(19) United States
(12) Patent Application Publication
(10) Pub. No.: US 2004/0093292 A1
(43) Pub. Date: May 13, 2004

(54) Methods and apparatus for provision of entitlement services

(76) Inventors: Stan D. Shurygailo, Boulder, CO (US); Erika B. Klein, Superior, CO (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 10/294,809

(22) Filed: Nov. 13, 2002

(51) Int. Cl. G06F 17/60

(52) U.S. Cl. 705/35

(57) ABSTRACT

Disclosed are novel methods and apparatus for provision of efficient, effective, and/or flexible provision of entitlement services. In accordance with an embodiment of the present invention, a method of providing an entitlement is disclosed. The method includes: receiving a request for the entitlement; verifying the entitlement is granted; creating the granted entitlement; storing information corresponding to the requested entitlement; tracking a consumption of the entitlement based on the stored information; and accessing the entitlement so long as at least one use of the entitlement remains based on the stored information; and an expiration date corresponding to the entitlement is unreached.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. The following notice applies to the software and data as described below and in the drawings hereto: Copyright© 2002, Sun Microsystems, Inc., All Rights Reserved.

### FIELD OF INVENTION

The present invention generally relates to the field of entitlement. More specifically, an embodiment of the present invention provides and tracks entitlement services.

### BACKGROUND OF INVENTION

As the Internet becomes increasingly a part of everyday life, the number of users utilizing the Web to perform commercial transactions (such as e-commerce) is growing exponentially. The always-available services through Web pages are contributing to this growth. For example, a user in a different time zone than a service provider does not have to worry about the customer service hours of operation when utilizing a Web site-based customer service tool. As a result of its many benefits, e-commerce is envisioned to become more commonplace than traditional commerce in the coming years.

Larger companies are also actively participating in the commercial use of the Internet. One problem with today's Internet-based solutions, however, is that tracking access and usage of services is not efficient. For example, if a user buys a book off the Web, the book is ordered and sent to the user once the money is collected. Tracking access and usage of services is, however, not as clear-cut over the Web. The steps involved in traditional service tracking not utilizing the Web can be cumbersome and time-consuming.

Similar problems also exist when utilizing the traditional methods (e.g., telephone or on-site). This is particularly challenging when the method of delivery is not bound at purchase time, but at the time the customer requests the service, and the request for service can be made by several alternate methods, of which the Web is one.

### SUMMARY OF INVENTION

The present invention, which may be implemented utilizing a general-purpose digital computer, in certain embodiments of the present invention, includes novel methods and apparatus to provide efficient, effective, and/or flexible provision of entitlement services. In accordance with an embodiment of the present invention, a computer system for providing an entitlement is disclosed. The computer system includes: a communication channel to receive a request for the entitlement; a computer facility to verify the entitlement is granted and create the entitlement; and a storage device to store information corresponding to the created entitlement. The entitlement may have a type selected from a group comprising an incident entitlement and a subscription entitlement.

In another embodiment of the present invention, a single entitlement may be created for all uses of a granted subscription entitlement.

In a further embodiment of the present invention, a different entitlement may be created for each purchased incident entitlement.

In yet another embodiment of the present invention, the stored information may indicate a status of the created entitlement selected from a group comprising available, expired, locked, completed, and canceled.

In a different embodiment of the present invention, a method of providing an entitlement is disclosed. The method includes: receiving a request for the entitlement; verifying the entitlement is granted; creating the granted entitlement; storing information corresponding to the requested entitlement; tracking a consumption of the entitlement based on the stored information; and accessing the entitlement so long as at least one use of the entitlement remains based on the stored information; and an expiration date corresponding to the entitlement is unreached.

In an additional embodiment of the present invention, the method may further include repeating the accessing and tracking acts until an event corresponding to the entitlement is reached. The event may be selected from a group comprising expired, completely consumed, non-existent, and canceled.

### BRIEF DESCRIPTION OF DRAWINGS

The present invention may be better understood and its numerous objects, features, and advantages made apparent to those skilled in the art by reference to the accompanying drawings in which:

FIG. 1 illustrates an exemplary computer system 100 in which certain embodiments of the present invention may be implemented;

FIG. 2 illustrates an exemplary purchase state diagram 200 in accordance with an embodiment of the present invention;

FIG. 3 illustrates an exemplary entitlement state diagram 300 in accordance with an embodiment of the present invention; and

FIG. 4 illustrates an exemplary consumption state diagram 400 in accordance with an embodiment of the present invention.

The use of the same reference symbols in different drawings indicates similar or identical items.

### DETAILED DESCRIPTION

In the following description, numerous details are set forth. It will be apparent, however, to one skilled in the art that embodiments of the present invention may be practiced without these specific details. In other instances, well-known structures, devices, and techniques have not been shown in detail, in order to avoid obscuring the understanding of the description. The description is thus to be regarded as illustrative instead of limiting.

Reference in the specification to “one embodiment” or “an embodiment” means that a particular feature, structure, or characteristic described in connection with the embodiment is included in at least an embodiment of the invention. The appearances of the phrase “in one embodiment” in various places in the specification are not necessarily all referring to the same embodiment.

Also, select embodiments of the present invention include various operations, which are described herein. The operations of the embodiments of the present invention may be performed by hardware components or may be embodied in machine-executable instructions, which may be in turn utilized to cause a general-purpose or special-purpose processor, or logic circuits programmed with the instructions to perform the operations. Alternatively, the operations may be performed by a combination of hardware and software.

Moreover, embodiments of the present invention may be provided as computer program products, which may include machine-readable medium having stored thereon instructions used to program a computer (or other electronic devices) to perform a process according to embodiments of the present invention. The machine-readable medium may include, but is not limited to, floppy diskettes, optical disks, compact disc-read only memories (CD-ROMs), and magneto-optical disks, read-only memories (ROMs), random-access memories (RAMs), erasable programmable ROMs (EPROMs), electrically EPROMs (EEPROMs), magnetic or optical cards, flash memory, or other types of media or machine-readable medium suitable for storing electronic instructions and/or data.

Additionally, embodiments of the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Before describing an exemplary environment in which various embodiments of the present invention may be implemented, some terms that will be used throughout this patent application will briefly be defined:

As used herein, “entitled” means the right to benefit from a tangible or intangible asset.

As used herein, “entitlement” means the way one may track to determine whether a user is entitled.

As used herein, “incident” means an entitlement with limited consumption and/or for a specified period of time.

As used herein, “subscription” means an entitlement with unlimited consumption and/or for a specified period of time.

As used herein, “site” means a relatively large quantity of subscriptions.

As used herein, “consumption” means usage of an entitlement.

As used herein, “pack” means one or more entitlements associated with each other.

As used herein, “CT” means cancellation and/or rejection in a tool such as a purchase tool and/or a consumption tool by, for example, and administrator as further discussed herein.

As used herein, “CF” means cancellation and/or rejection in the future by, for example, a user as further discussed herein.

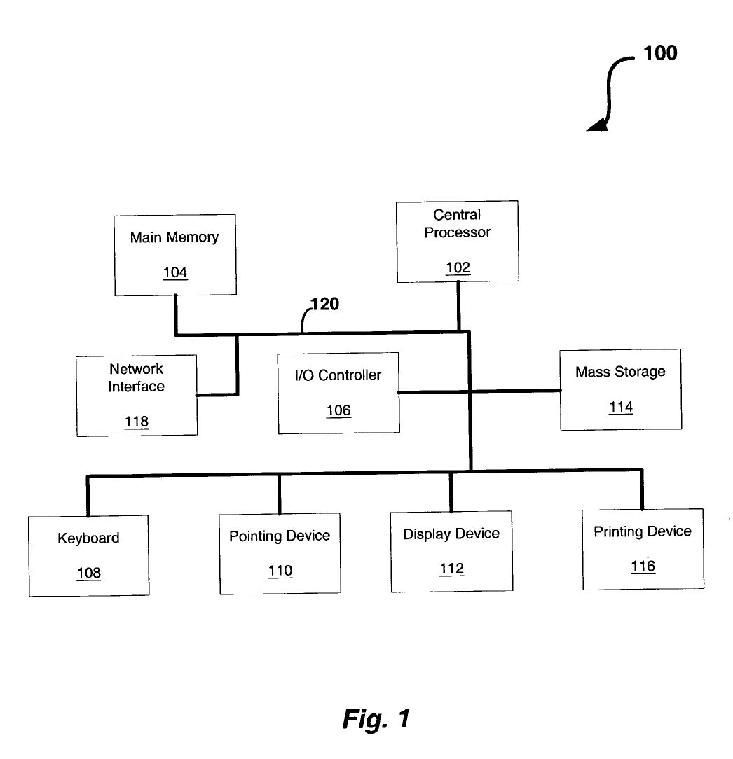

FIG. 1 illustrates an exemplary computer system 100 in which certain embodiments of the present invention may be implemented. The system 100 comprises a central processor 102, a main memory 104, an input/output (I/O) controller 106, a keyboard 108, a pointing device 110 (e.g., mouse, track ball, pen device, or the like), a display device 112, a mass storage 114 (e.g., a nonvolatile storage such as a hard disk, an optical drive, and the like), and a network interface 118. Additional input/output devices, such as a printing device 116, may be included in the system 100 as desired. As illustrated, the various components of the system 100 communicate through a system bus 120 or similar architecture.

In accordance with an embodiment of the present invention, the computer system 100 includes a Sun Microsystems computer utilizing a SPARC microprocessor available from several vendors (including Sun Microsystems, Inc., of Santa Clara, Calif.). Those with ordinary skill in the art understand, however, that any type of computer system may be utilized to embody the present invention, including those made by Hewlett Packard of Palo Alto, Calif., and IBM-compatible personal computers utilizing Intel microprocessor, which are available from several vendors (including IBM of Armonk, N.Y.). Also, instead of a single processor, two or more processors (whether on a single chip or on separate chips) can be utilized to provide speedup in operations. It is further envisioned that the processor 102 may be a complex instruction set computer (CISC) microprocessor, a reduced instruction set computing (RISC) microprocessor, a very long instruction word (VLIW) microprocessor, a processor implementing a combination of instruction sets, and the like.

The network interface 118 provides communication capability with other computer systems on a same local network, on a different network connected via modems and the like to the present network, or to other computers across the Internet. In various embodiments of the present invention, the network interface 118 can be implemented utilizing technologies including, but not limited to, Ethernet, Fast Ethernet, Gigabit Ethernet (such as that covered by the Institute of Electrical and Electronics Engineers (IEEE) 801.1 standard), wide-area network (WAN), leased line (such as T1, T3, optical carrier 3 (OC3), and the like), analog modem, digital subscriber line (DSL and its varieties such as high bit-rate DSL (HDSL), integrated services digital network DSL (IDSL), and the like), cellular, wireless networks (such as those implemented by utilizing the wireless application protocol (WAP)), time division multiplexing (TDM), universal serial bus (USB and its varieties such as USB II), asynchronous transfer mode (ATM), satellite, cable modem, and/or FireWire.

Moreover, the computer system 100 may utilize operating systems such as Solaris, Windows (and its varieties such as CE, NT, 2000, XP, ME, and the like), HP-UX, IBM-AIX, PALM, UNIX, Berkeley software distribution (BSD) UNIX, Linux, Apple UNIX (AUX), Macintosh operating system (Mac OS) (including Mac OS X), and the like. Also, it is envisioned that in certain embodiments of the present invention, the computer system 100 is a general purpose computer capable of running any number of applications such as those available from companies including Oracle, Siebel, Unisys, Microsoft, and the like.

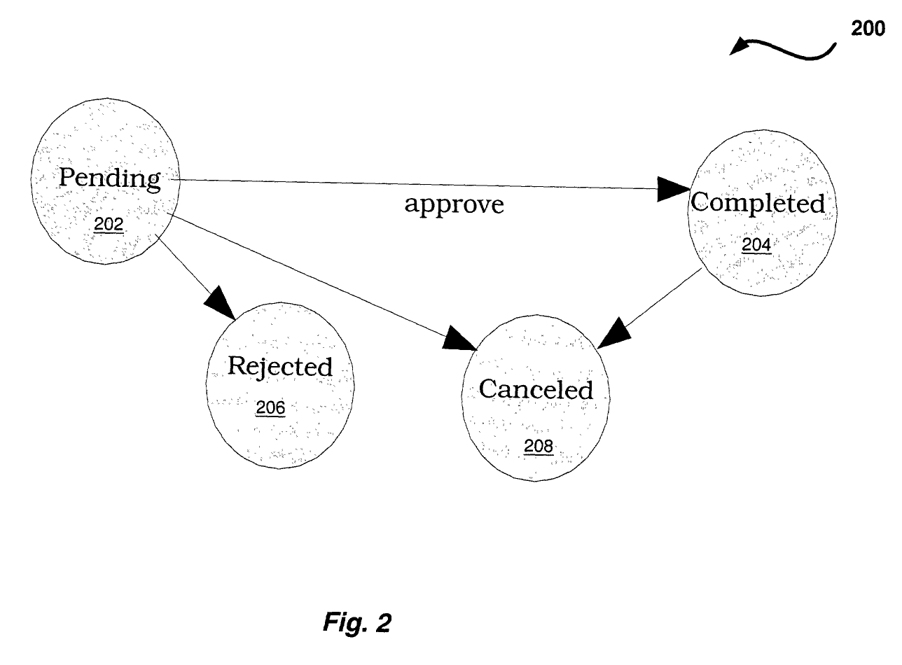

FIG. 2 illustrates an exemplary purchase state diagram 200 in accordance with an embodiment of the present invention. The purchase (or purchase order (PO)) state diagram 200 provides exemplary system states for a purchased product. In one embodiment of the present invention, the state diagram 200 may be part of an e-commerce system. In accordance with an embodiment of the present invention, it is envisioned that a PO is but one form of payment that can be utilized. Other payment methods may include a money order, a credit card payment, a wire transfer, a cash-on-deliver (COD), and the like. The diagram 200 contains four states: Pending 202, Completed 204, Rejected 206, and Canceled 208.

Table 1 below provides an exemplary summary of the transitions between the states of FIG. 2 and the corresponding triggering events in accordance with an embodiment of the present invention.

TABLE 1
Purchase States

| Purchase State | Transition to . . . | Trigger |
|---|---|---|
| Pending | Rejected | PO Rejected via, for |
| | | example, a tool. |
| | Canceled | PO/Credit Card (CC) |
| | | Canceled |
| | Completed | PO/CC approval |
| Completed | Canceled | PO/CC Canceled |

The Pending state 202 is the initial state within the purchase state diagram 200. The Pending state 202 is representative of a purchase not yet completed. The Pending state 202 may be utilized for credit card pre-authorization (e.g., to check that funds are available) or acceptance of a purchase order not yet validated. The Completed state 204 is representative of a purchase where the commitment to pay has been received from the purchaser. For example, when a credit card post authorization occurs or when a purchase order is validated, then the purchase transaction will be placed into the Completed state 204. The Rejected state 206 is representative of a purchase that could not go through (in an embodiment of the present invention upon verification), for example, because the credit card did not have the appropriate funds, the credit card was expired, the purchase order was invalid, the purchase order was not received, and the like. The Canceled state 208 is representative of the purchase being deleted. This state can occur, for example, because a refund is requested, a purchase order fax invoice is never received from the customer, and the like.

In an embodiment of the present invention, for a purchase to transition from the Pending state 202 to the Completed state 204, the PO needs be first received by the seller. In another embodiment of the present invention, for a purchase to transition from the Pending state 202 to the Rejected state 206, the PO may not have been received. Additionally, for a purchase to transition from the Pending state 202 to the Canceled state 208, a change in consumer interest or an inability to complete the purchase process may have occurred. In a further embodiment of the present invention, for a purchase to transition from the Completed state 204 to the Canceled state 208, a change in consumer interest may have occurred and a refund may be in order.

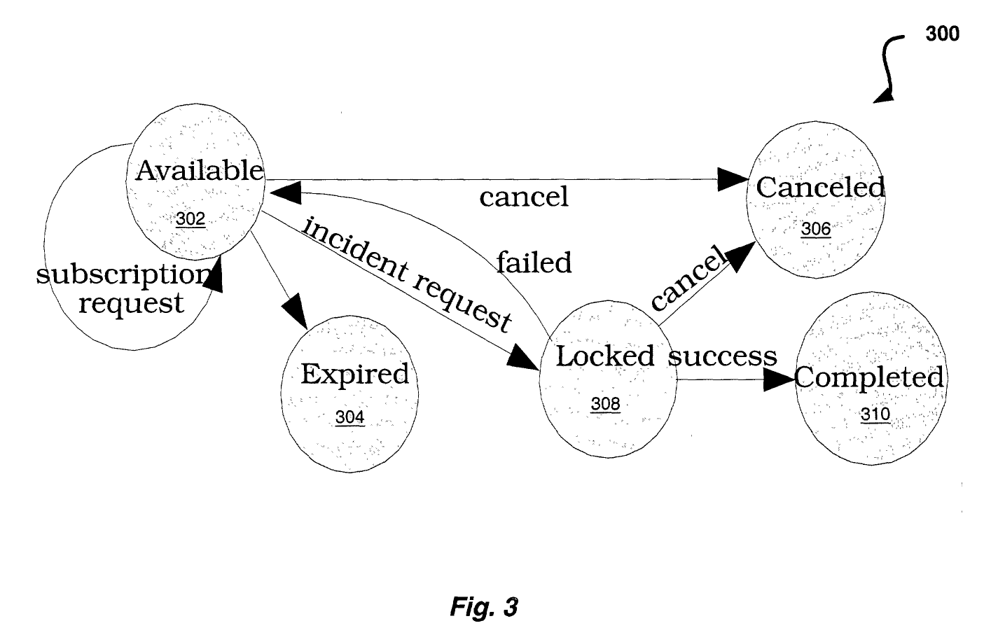

FIG. 3 illustrates an exemplary entitlement state diagram 300 in accordance with an embodiment of the present invention. In accordance with one embodiment of the present invention, the entitlement state diagram 300 provides the system states for an entitlement. The diagram 300 represents incident and subscription entitlements within one exemplary model. There are five states for an entitlement: Available 302, Expired 304, Canceled 306, Locked 308, and Completed 310. The Available state 302 is the default state for an entitlement. The Available state 302 represents an active or otherwise usable entitlement. The Canceled state 306 represents a non-usable entitlement that is due to, for example, security fraud or consumer refund requested. The Expired state 304 represents a subscription or incident entitlement that has past its expiration. The Locked state 308 represents entitlements when the request to consume has been received but not yet fulfilled. The Completed state 310 represents an incident entitlement that has been successfully fulfilled.

Table 2 below provides an exemplary summary of the transitions between the states of FIG. 3 and the corresponding triggering events in accordance with an embodiment of the present invention.

TABLE 2
Entitlement States

| Entitlement State | Transition to . . . | Trigger |
|---|---|---|
| Available | Available | A consumption of a |
| | | subscription is required |
| | Canceled | Entitlement canceled (e.g., |
| | | via a tool) |
| | Locked | A consumption of an |
| | | Incident is requested |
| | Expired | Entitlement is no longer |
| | | usable |
| Locked | Canceled | Entitlement canceled (e.g., |
| | | via a tool) |
| | Completed | Incident consumption |
| | | occurred |
| | Available | Incident consumption failed |

For the transition from the Available state 302 to the Canceled state 306, a consumer request may have been made for a refund. Hence, the entitlement(s) will be removed and the consumer will receive a refund or service credit. If the entitlement is canceled, then the transition to the Canceled state 208 in the Purchase State Diagram 200 triggers the cancellation of the entitlement as well. On the expiration date, entitlements in the Available state 302 move to the Expired state 304. Accordingly, the subscription or incident entitlement will expire and will no longer be usable.

In accordance with an embodiment of the present invention, each entitlement may have an expiration date associated with it upon creation. When consumption for a subscription occurs, the entitlement moves from the Available state 302 to the Available state 302; thus, subscription entitlements are not used up and remain available until they expire or are canceled. In accordance with another embodiment of the present invention, subscription entitlements may have unlimited consumption, for example, for a specified period of time. For an incident entitlement request for consumption, entitlements transition from the Available state 302 to the Locked state 308; thus, once used, incident entitlements are no longer available.

In one embodiment of the present invention, incident entitlements may have limited consumption and/or a specified amount of time associated with them. When the consumption of an incident entitlement does not occur, the transition from the Locked state 308 to the Canceled state 306 may occur. When an incident entitlement is successfully consumed (i.e., the user is not entitled to use the entitlement anymore, even though the entitlement may still exist), the transition from the Locked state 308 to the Completed state 310 takes place. For the transition from the Locked state 308 to the Available state 302, the incident entitlement consumption request needs to fail to be fulfilled.

In a further embodiment of the present invention, each subscription or incident entitlement can be consumed. Because subscription entitlements may have unlimited consumption requests, they may never reach the Completed state 310. Therefore, each subscription entitlement may be available immediately after requesting consumption. Furthermore, when a request to consume an incident entitlement is made, it may no longer be available once consumption starts. In accordance with another embodiment of the present invention, incident entitlements may have a quantity of one associated with them that requires, for example, decrementing upon successful consumption or incrementing upon a need for providing a credit.

In accordance with yet another embodiment of the present invention, when a purchase is made for an incident or subscription-based product, entitlements may be created representative of the product purchased. For example, if a purchaser buys a support package, which contains five incidents, there will be five entitlements created, one for each incident purchased. If a purchaser buys a subscription to a service, then there may be one entitlement created for the service subscription. An entitlement can be created when the purchase is in the Pending state 202 or the Completed state 204. Business logic, on a case-by-case basis, may dictate, which state the entitlement, will be generated from. Although, entitlements are not necessarily dependent on a purchase in order to be created or otherwise to exist.

In a further embodiment of the present invention, entitlements may have one or more of the following characteristics: one or more entitlements can be created for each purchase; for each incident purchased, one entitlement may be created; for each subscription purchased, typically one entitlement may be created, although subscriptions could conceivably share an entitlement; and various rules can apply about what purchase states or other conditions trigger the creation of an entitlement. The latter may be the rules under which service is given. For example, for one particular service, the entitlement might be created in the Pending state 202 if the purchase amount is over a threshold amount, but not created until the Completed state 204 if it is under that amount. For another service, perhaps all purchases must be completed before the entitlement is created (i.e., service is given).

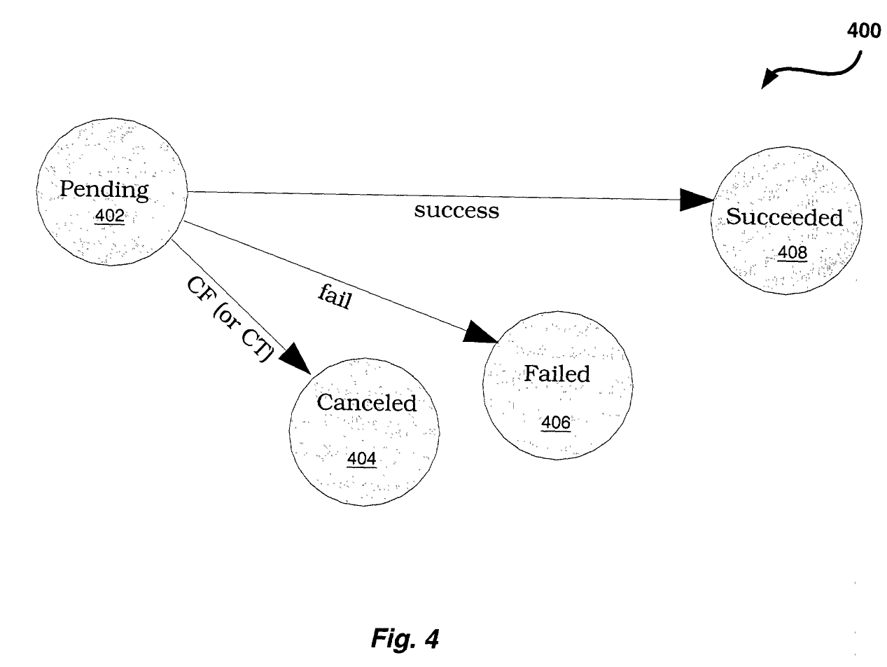

FIG. 4 illustrates an exemplary consumption state diagram 400 in accordance with an embodiment of the present invention. The consumption (or request) state diagram 400 includes four states: Pending 402, Canceled 404, Failed 406, and Succeeded 408. When a request is made for either an incident or subscription entitlement, a consumption (and a corresponding consumption state) are created, which are represented in the state diagram 400. Accordingly, the consumption state diagram 400 provides the system states for each individual consumption request.

As illustrated in FIG. 4, there are four possible states for a consumption request. The Pending state 402 is the initial state upon creation of this instance that requests entry into prior to completion. A request can move from Pending state 402 to the Succeeded state 408, the Failed state 406, or the Canceled state 404. The Succeeded state 408 is representative of a successful consumption. The Failed state 406 is representative of an unsuccessful consumption. The Canceled state 404 is representative of a request to cancel by, for example, an administrator or a user within a feature.

Table 3 below provides an exemplary summary of the transitions between the states of FIG. 4 and the corresponding triggering events in accordance with an embodiment of the present invention.

TABLE 3
Consumption States

| Consumption State | Transition to . . . | Trigger |
|---|---|---|
| Pending | Succeeded | Successful consumption |
| | Failed | No consumption |
| | Canceled | Incomplete consumption |

In accordance with an embodiment of the present invention, an entitlement system (e.g., including server computers such as those discussed with respect to FIG. 1) may store one or more entitlements as a site, subscription pack, incident pack, incident, and/or subscription. Furthermore, the stored information regarding each entitlement may include data regarding the purchased product (such as a service product), service type, expiration, entitlement state, number of uses available, and any associated assets. In another embodiment of the present invention, the entitlement may be associated with a single user and/or a user group. Additionally, the entitlement may be associated with one or more tangible/intangible assets.

In a further embodiment of the present invention, identification of the entitlement may be by any of its associated properties, and does not have to be by association with the purchase. For example, a user may request a service for a machine by that machine's serial number; the user does not have to be the same user or in any other way associated with the purchaser, or provide any other information about the purchase or entitlement than the serial number. In other words, the key value to associate the request (consumption) with the entitlement can be any data associated with an entitlement. Different data may be used for this association for different services that use our entitlement system.

The foregoing description has been directed to specific embodiments of the present invention. It will be apparent to those with ordinary skill in the art that modifications may be made to the described embodiments of the present invention, with the attainment of all or some of the advantages. For example, the techniques of the present invention may be utilized for provision of discounts (such as coupons, vouchers, and the like), royalty points, frequent shopping credit, and the like. Therefore, it is the object of the appended claims to cover all such variations and modifications as come within the spirit and scope of the invention.

What is claimed is:

1. A method of providing an entitlement, the method comprising:
receiving a request for the entitlement;
verifying the entitlement is granted;
creating the granted entitlement, the entitlement having a type selected from a group comprising an incident entitlement and a subscription entitlement, wherein a single entitlement is created for all uses of a granted subscription entitlement and a different entitlement is created for each granted incident entitlement;
storing information corresponding to the requested entitlement;
tracking a consumption of the entitlement based on the stored information; and
accessing the entitlement so long as:
at least one use of the entitlement remains based on the stored information; and
an expiration date corresponding to the entitlement is unreached.

2. The method of claim 1 wherein the stored information is selected from a group comprising product, service type, expiration, entitlement state, number of uses available, and an associated asset.

3. The method of claim 1 further including at least one of:
decrementing a use from the stored information each time a unit of the entitlement is consumed; and
incrementing upon a need for providing a credit.

4. The method of claim 1 wherein the creating act occurs substantially simultaneously with a purchase of a product corresponding to the entitlement.

5. The method of claim 1 wherein the entitlement type is further selected from a group comprising a site entitlement, a subscription pack entitlement, and an incident pack entitlement.

6. The method of claim 1 wherein the entitlement has a state selected from a group comprising available, expired, locked, completed, and canceled.

7. The method of claim 6 further including returning to the available state when:
at least one use remains based on the stored information; and
an expiration date corresponding to the entitlement is unreached.

8. The method of claim 1 further including repeating the accessing and tracking acts until an event corresponding to the entitlement is reached, the event being selected from a group comprising expired, completely consumed, non-existent, and canceled.

9. An article of manufacture for providing an entitlement, the article comprising:
a machine readable medium that provides instructions that, if executed by a machine, will cause the machine to perform operations including:
receiving a request for the entitlement;
verifying the entitlement is granted;
creating the granted entitlement, the entitlement having a type selected from a group comprising an incident entitlement and a subscription entitlement, wherein a single entitlement is created for all uses of a granted subscription entitlement and a different entitlement is created for each granted incident entitlement;
storing information corresponding to the requested entitlement;
tracking a consumption of the entitlement based on the stored information; and
accessing the entitlement so long as:
at least one use of the entitlement remains based on the stored information; and
an expiration date corresponding to the entitlement is unreached.

10. The article of claim 9 wherein the operations further include at least one of:
decrementing a use from the stored information each time a unit of the entitlement is consumed; and
incrementing upon a need for providing a credit.

11. The article of claim 9 wherein the operations further include repeating the accessing and tracking acts until an event corresponding to the entitlement is reached, the event being selected from a group comprising expired, completely consumed, non-existent, and canceled.

12. The article of claim 9 wherein the entitlement type is further selected from a group comprising a site entitlement, a subscription pack entitlement, and an incident pack entitlement.

13. The article of claim 9 wherein the creating operation occurs substantially simultaneously with a purchase of a product corresponding to the entitlement.

14. A computer system for providing an entitlement, the computer system comprising:
a communication channel to receive a request for the entitlement;
a computer facility to verify the entitlement is granted and create the entitlement, the entitlement having a type selected from a group comprising an incident entitlement and a subscription entitlement, wherein a single entitlement is created for all uses of a granted subscription entitlement and a different entitlement is created for each granted incident entitlement; and
a storage device to store information corresponding to the created entitlement, the stored information indicating a status of the created entitlement selected from a group comprising available, expired, locked, completed, and canceled.

15. The computer system of claim 14 wherein the stored information is selected from a group comprising product, service type, expiration, entitlement state, number of uses available, and an associated asset.

16. The computer system of claim 14 wherein the creating act occurs substantially simultaneously with a purchase of a product corresponding to the entitlement.

17. The computer system of claim 14 wherein the entitlement type is further selected from a group comprising a site entitlement, a subscription pack entitlement, and an incident pack entitlement.

18. The computer system of claim 14 wherein the communication channel is selected from a group comprising Ethernet, Fast Ethernet, WAN, leased line, analog modem, digital subscriber line, integrated services digital network DSL (IDSL), cellular, wireless network, time division multiplexing (TDM), universal serial bus, asynchronous transfer mode (ATM), satellite, cable modem, and FireWire.

19. The computer system of claim 18 wherein the leased line is selected from a group comprising T1, T3, and optical carrier 3 (OC3).

20. The computer system of claim 14 wherein the computer facility is implemented on a computer device running an operating system selected from a group comprising Solaris, Windows, HP-UX, IBM-AIX, PALM, UNIX, Berkeley software distribution (BSD) UNIX, Linux, Apple UNIX (AUX), and Macintosh operating system (Mac OS).
